(19) United States
(12) Patent Application Publication
(10) Pub. No.: US 2008/0112506 A1
(43) Pub. Date: May 15, 2008

(54) TRANSMISSION POWER OPTIMIZATION

(75) Inventor: Peter N. Strong, Newton Abbot (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/558,943

(22) Filed: Nov. 13, 2006

(51) Int. Cl. H04L 27/04

(52) U.S. Cl. 375/300

(57) ABSTRACT

A transceiver at one end of a variable data rate, time division duplex (TDD), adaptively modulated, point-to-point radio link transmits one or more pulses at different amplitude levels during a settling period of the transceiver's power amplifier. The highest level of the pulses is set to a level higher than the mean level of an OFDM symbol in a transmit burst immediately following the transmitted pulses, and is incrementally increased with each successive burst. A second transceiver at the opposite end of the link receives the transmitted pulses as time domain samples, normalizes the samples, and performs a cross correlation of the samples corresponding to the received pulses. When the cross correlation indicates that the power amplifier is operating at a maximal power level with regard to the amplifier linearity and the modulation mode and coding rate currently in use, the incremental increase of the transmission power ceases.

### CROSS REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

The present invention relates generally to wireless broadband communications systems, and more specifically to a system and method of maximizing the transmission power provided by a wireless communications system over a variable data rate, time division duplex (TDD), adaptively modulated, point-to-point radio link, for use in increasing the data capacity of the radio link.

Wireless broadband communications systems are known that employ multiple sub-carriers in an orthogonal frequency division modulation (OFDM) signal waveform and adaptive modulation and coding techniques for transmitting variable rate data streams as wireless signals over time division duplex (TDD) point-to-point radio links. Such wireless communications systems typically include a first transceiver disposed at one end of a TDD point-to-point radio link, and a second transceiver disposed at the opposite end of the radio link. Each of the transceivers includes a power amplifier configured to amplify the wireless signals, and to provide the amplified signals to an antenna for subsequent transmission over the radio link. More specifically, each transceiver is configured to transmit the amplified signals over one or more communications channels using specified error correction coding and modulation techniques, to capture transmitted wireless signals, and to employ specified signal processing techniques for decoding and demodulating the captured signals to recover user data. Such wireless communications systems typically employ adaptive modulation and coding techniques to adjust transmission parameters such as the modulation mode and the coding rate, thereby maximizing the bandwidth of the radio link while maintaining the signal-to-noise ratio at an acceptable level.

In a typical wireless broadband communications system, the performance requirements imposed upon the power amplifier included in each transceiver can be stringent. For example, the transceiver may employ a modulation scheme that requires the power amplifier to be highly linear to avoid introducing spurious components onto the transmitted wireless signal. However, such high linearity can be both difficult and costly to achieve, especially when the power amplifier is called upon to provide a high level of power output. In wireless communications systems that employ adaptive modulation and coding techniques, such high power output levels can often be exploited to increase the data rate of data streams transmitted over TDD point-to-point radio links. Although known digital pre-distortion techniques may be employed in such systems to compensate for the non-linear transfer characteristics of the power amplifier, it would be desirable to have an improved technique of maximizing the transmission power of the power amplifier that allows the data capacity of the radio link to be increased, while satisfying the stringent performance requirements of the power amplifier.

### BRIEF SUMMARY OF THE INVENTION

In accordance with the present invention, a system and method is disclosed for maximizing the transmission power provided by a wireless broadband communications system over a variable data rate, time division duplex (TDD), adaptively modulated, point-to-point radio link. The presently disclosed system and method may be employed by the wireless communications system to determine how close a transceiver's power amplifier is to non-linear operation, and to set the transmission power of the power amplifier to a maximal level to achieve an acceptable level of distortion at the amplifier output. The wireless communications system may then employ an adaptive modulation and coding technique and/or a digital pre-distortion technique consistent with the maximal power level setting to increase the data capacity of the radio link.

In one embodiment, the presently disclosed method is performed by a wireless broadband communications system that includes first and second transceivers disposed at opposite ends of a TDD point-to-point radio link. Each of the transceivers includes a power amplifier. In one mode of operation, the first transceiver transmits, in succession, one or more pulses at different power levels during either the same settling period, or successive settling periods, of the power amplifier. As defined herein, the settling period of the power amplifier corresponds to that period of time during which the transfer characteristics of the power amplifier stabilize, after the power amplifier is enabled or “turned-on” and the transceiver transitions from receiver operation to transmitter operation. The first transceiver may then generate an orthogonal frequency division modulation (OFDM) transmission burst (“transmit burst”) including at least one OFDM symbol immediately following the power amplifier settling period. The pulses and the OFDM symbol in the transmit burst are generated by the first transceiver as time domain samples. The first transceiver sets the highest power level of the pulses to a level higher than the mean level of the OFDM symbol in the transmit burst. As a result, as the first transceiver incrementally increases the transmission power of the power amplifier, the pulse having the highest power level will cause the power amplifier to operate in or near the non-linear region before the other pulse(s) within the settling period, and before the OFDM symbol in the transmit burst immediately following the settling period.

Next, the second transceiver disposed at the opposite end of the TDD point-to-point radio link receives the transmitted pulses and the OFDM symbol in the transmit burst. The second transceiver is configured to normalize the time domain samples corresponding to the received pulses and the OFDM symbol, and to perform a cross correlation of the normalized pulses. In the event distortion is introduced onto the pulse with the highest power level, due to the power amplifier operating in or near the non-linear region, the magnitude of the peak of the cross correlation is reduced and/or the phase of the cross correlation is changed. Because the time domain samples are normalized by the second transceiver, the RMS voltage (V_{RMS}) of the received burst is constant regardless of the transmission power setting. The transmission power therefore does not affect the cross correlation result, except by the introduction of distortion from operating in or near the non-linear region. The peak magnitude and/or the phase of the cross correlation of the received pulses may then be employed by the second transceiver as an indication of the proximity of the power amplifier within the first transceiver to the non-linear region.

In the presently disclosed embodiment, the first transceiver incrementally increases the transmission power of the power amplifier in steps with each successive transmit burst. These incremental step increases of the transmission power cease when the peak magnitude and/or the phase of the cross correlation of the received pulses indicate that the power amplifier is operating at a maximal power level with regard to an acceptable level of distortion at the amplifier output, and with regard to the modulation mode and the coding rate currently being employed at the first transceiver. Such indications of the peak magnitude and/or the phase of the cross correlation of the received pulses may be provided to the first transceiver by the second transceiver over a reverse radio link. Next, the second transceiver continues to perform cross correlations of pulses associated with subsequent transmit bursts, and the first transceiver increases or decreases the transmission power of the power amplifier based upon the measure of cross correlation, as needed, to maintain a maximal power level. In an exemplary embodiment, the first transceiver employs adaptive modulation and coding techniques consistent with the maximal power level of the power amplifier to increase the data capacity of the link. In addition, the first transceiver can adjust a digital pre-distortion characteristic applied to the wireless signals before amplification by the power amplifier based upon the measure of cross correlation. For example, the first transceiver may adjust the digital pre-distortion characteristic in an iterative manner to maximize the magnitude of the cross correlation peak and/or to minimize the phase change of the cross correlation. In the presently disclosed embodiment, the first transceiver adjusts the transmission power of the power amplifier, and adjusts the digital pre-distortion characteristic, based upon measures of the cross correlation of pulses associated with separate, typically alternate, transmit bursts.

By determining how close a transceiver's power amplifier is to non-linear operation, setting the transmission power of the power amplifier to a maximal level to achieve an acceptable level of distortion at the amplifier output, and employing an adaptive modulation and coding technique and/or a digital pre-distortion technique consistent with the maximal power level setting of the power amplifier, a wireless broadband communications system can significantly increase the data capacity of a variable data rate, time division duplex (TDD), point-to-point radio link.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a block diagram of a wireless broadband communications system according to the present invention;

FIG. 2 is a diagram of the power envelope of an OFDM transmission burst generated by the wireless communications system of FIG. 1, including two pulses within the settling period of a power amplifier included in the system, for use in determining how close the power amplifier is to non-linear operation;

FIGS. 3a-3b are diagrams of the in-phase and quadrature components of the two pulses of FIG. 2, and diagrams of the cross correlations of the in-phase and quadrature components of the two pulses, in which each of the pulses is within the linear operating range of the power amplifier;

FIGS. 4a-4b are diagrams of the in-phase and quadrature components of the two pulses of FIG. 2, and diagrams of the cross correlations of the in-phase and quadrature components of the two pulses, in which one of the two pulses is in the non-linear region of the power amplifier; and

FIG. 5 is a flow diagram of a method of operating the wireless communications system of FIG. 1.

### DETAILED DESCRIPTION OF THE INVENTION

A system and method is disclosed for maximizing the transmission power provided by a wireless broadband communications system over a variable data rate, time division duplex (TDD), adaptively modulated, point-to-point radio link. The presently disclosed system and method may be employed by the wireless communications system to determine how close a transceiver's power amplifier is to non-linear operation, and to set the transmission power of the power amplifier to a maximal level to achieve an acceptable level of distortion at the amplifier output. The wireless communications system may then employ an adaptive modulation and coding technique and/or a digital pre-distortion technique consistent with the maximal power level setting to increase the data capacity of the radio link.

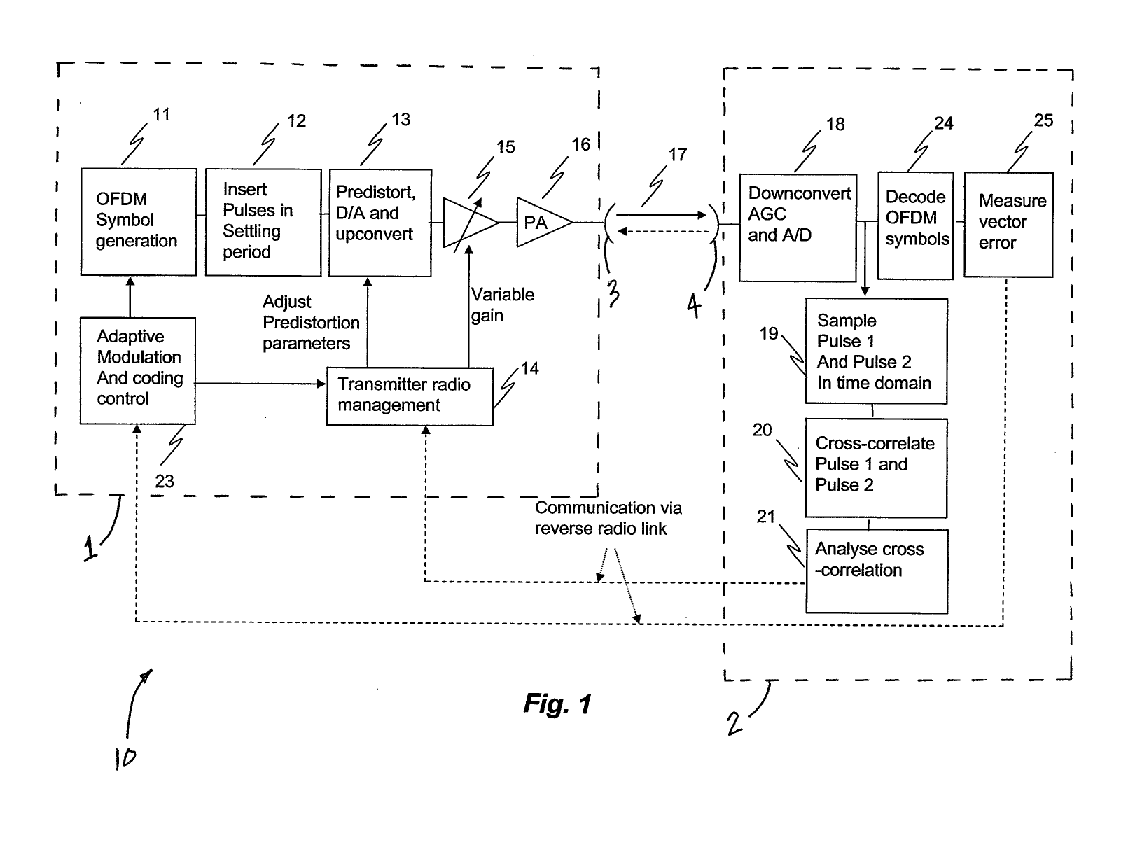

FIG. 1 is an illustrative embodiment of a wireless broadband communications system 10, in accordance with the present invention. The wireless communications system 10 includes a transmitter 1, a transmit antenna 3, a receiver 2, and a receive antenna 4. In the illustrated embodiment, the transmitter 1 and the transmit antenna 3 are disposed at one end of a radio link 17, and the receiver 2 and the receive antenna 4 are disposed at the opposite end of the radio link 17, which is a time division duplex (TDD) point-to-point radio link. The wireless communications system 10 is configured to employ multiple sub-carriers in an orthogonal frequency division modulation (OFDM) waveform to transmit data streams as wireless signals over the radio link 17. It is noted that in a typical TDD system, at least one transmitter and at least one receiver are provided at each end of a radio link, thereby allowing the system to transmit and receive data signals alternately at each end of the link. FIG. 1 depicts the transmitter 1 disposed at one end of the radio link 17 and the receiver 2 disposed at the other end of the radio link 17 for clarity of illustration. It should be appreciated that the wireless communications system 10 may be employed in either point-to-point or point-to-multipoint applications.

As shown in FIG. 1, the transmitter 1 includes an OFDM symbol generator 11, a power amplifier 16, and a component 12 for inserting one or more pulses within the settling period of the power amplifier 16. The transmitter 1 also includes a component 13 for applying a digital pre-distortion to the OFDM symbols and the pulses, converting the symbols and pulses from digital to analog form, and up-converting the analog signals to radio frequency (RF) for subsequent transmission via the transmit antenna 3. In addition, the transmitter 1 includes a variable gain amplifier 15, an adaptive modulation and coding controller 23, and a transmitter radio management component 14. The receiver 2 includes a component 18 for down-converting the RF signals to analog baseband signals, performing an automatic gain control (AGC) function on the analog baseband signals, and converting the baseband signals from analog to digital form. The receiver 2 also includes an OFDM symbol decoder 24, and a component 25 for measuring the vector error associated with the received symbols. The component 25 provides a measure of the vector error to the adaptive modulation and coding controller 23 included in the transmitter 1 over a reverse radio link (not numbered). In addition, the receiver 2 includes a component 19 for sampling the received pulses in the time domain, a component 20 for performing a cross correlation of the time domain samples corresponding to the received pulses, and a component 21 for analyzing the measure of cross correlation, which subsequently provides analysis results to the transmitter radio management component 14 over the reverse radio link for controlling the digital pre-distortion component 13 and/or the variable gain amplifier 15.

It is noted that the performance requirements imposed upon the power amplifier 16 included in the transmitter 1 (see FIG. 1) can be stringent. For example, the modulation scheme employed by the transmitter 1 may require the power amplifier 16 to be highly linear to avoid introducing spurious components onto the transmitted wireless signal. Power amplifiers such as the power amplifier 16 typically have transfer characteristics that are linear within a specified range, up to a specified maximum power output level. In addition, safety margins are generally built into the design of such power amplifiers to allow for variations in the ambient temperature, variations in the tolerances of associated component values, and variations in frequency. Accordingly, power amplifiers like the power amplifier 16 may be capable of maintaining sufficient linearity at power output levels at least slightly above the specified maximum power output level of the amplifier.

It is further noted, however, that the maximum power output levels of power amplifiers within wireless communications systems may be limited, for example, by the terms of an operating license, and/or FCC (Federal Communications Commission) regulations within a particular geographical location. Nevertheless, there may be geographical locations in which regulations permit the use of transmission power output levels higher than those formally specified for the power amplifiers. In addition, wireless communications systems operating within these locations may be capable of employing adaptive modulation and coding techniques and/or digital pre-distortion techniques to exploit the higher power output levels of the power amplifiers, thereby increasing the data capacity of their associated radio links. In accordance with the present invention, the wireless communications system 10 of FIG. 1 employs adaptive modulation and coding techniques (e.g., non-constant envelope modulation) and/or digital pre-distortion techniques consistent with the increased power output levels of the power amplifier 16, whenever possible, to increase the data capacity of the radio link 17. In addition, the wireless communications system 10 employs more robust modulation modes and coding formats at times when such increased power output levels are restricted from use.

In an illustrative mode of operation, the transmitter 1 (see FIG. 1) transmits, in succession, one or more pulses at different transmission power output levels, during either the same settling period or successive settling periods of the power amplifier 16. These pulses are inserted within the settling period of the power amplifier 16 by the component 12 included in the transmitter 1. As discussed above, the transmitter 1 may be part of a transceiver (not shown) disposed at one end of the radio link 17. Within such a transceiver, the power amplifier 16 is typically disabled or “turned-off” when the receiver portion of the transceiver is enabled to prevent the noise floor from the transmitter 1 from de-sensitizing the receiver, and to avoid damaging the power amplifier 16 and/or a transmit/receive switch (not shown) connecting the transmitter 1 or the receiver to the antenna. While the power amplifier 16 is “turned-off”, the power amplifier 16 typically cools down, causing the transfer characteristics of the power amplifier 16 to change. The power amplifier 16 may then be enabled or “turned-on” in advance of an OFDM transmission burst (“transmit burst”), and a settling period may be provided to allow the transfer characteristics of the power amplifier 16 to stabilize. The settling period of the power amplifier 16 is defined herein as that period of time during which the transfer characteristics of the power amplifier 16 stabilize, after the power amplifier is “turned-on” and the transceiver transitions from receiver operation to transmitter operation. It is noted that the power amplifier 16 may not be employed to transmit data streams during the settling period because the amplitude and/or phase of the power amplifier transfer function may be changing with time during this period, thereby potentially distorting the transmitted wireless signal.

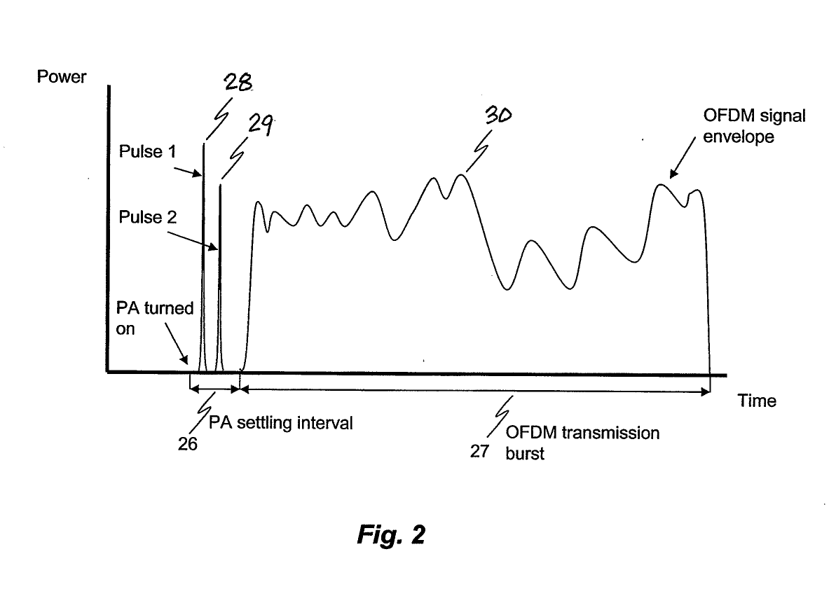

As described above, the settling period of the power amplifier 16 is employed for transmitting, in succession, one or more pulses at different transmission power output levels over the radio link 17. FIG. 2 depicts exemplary pulses 1-2 (reference numerals 28-29) associated with an exemplary power envelope of an OFDM transmission burst (“transmit burst”) generated by the transmitter 1 (see FIG. 1). As shown in FIG. 2, the pulses 28-29 are inserted within an interval 26, which corresponds to the settling period of the power amplifier 16 (see FIG. 1). In an alternative embodiment, the pulse 28 may be inserted within the settling period 26, and the pulse 29 may be inserted within a next successive settling period (not shown) of the power amplifier 16. It is noted that, in this alternative embodiment, time synchronization is maintained between the transmitter and receiver clocks (not shown) included in the transmitter 1 and the receiver 2, respectively, during the time between the successive pulses 28-29. The pulses 28-29 are employed by the wireless communications system 10 to obtain a measure of the linearity of the power amplifier 16.

As illustrated in FIG. 2, the amplitude of the pulse 28 is greater than the amplitude of the pulse 29. In the presently disclosed embodiment, the amplitude level of the pulse 28 is sufficiently above the mean level of the OFDM signal envelope 30 so that an increase in the transmission power of the power amplifier 16 will cause the amplifier to operate substantially in the non-linear region with regard to the pulse 28, while the pulse 29 and the OFDM symbol within the transmit burst 27 are not significantly degraded by the non-linearity of the amplifier. For example, in the wireless communications system 10 (see FIG. 1), the power amplifier 16 may be implemented as a class A amplifier. Further, if the wireless communications system 10 were operating with 256-QAM (quadrature amplitude modulation) and approximately 1000 sub-carriers in the OFDM signal waveform, then the nominal peak-to-mean ratio of the OFDM signal would be approximately 11 dB; i.e., the data error rate would not be significantly increased if the system 10 were operating with the mean level of the OFDM signal set at about 11 dB below the 1 dB compression point of the system. In this case, the pulse 28 would be set at a level approximately 11 dB above the mean level of the OFDM signal, and the pulse 29 would typically be set at a level approximately 6 dB below the level of the pulse 28. If, instead, the wireless communications system 10 were operating with BPSK (binary phase shift keying) and approximately 1000 sub-carriers in the OFDM signal waveform, then the nominal peak-to-mean ratio of the OFDM signal would be approximately 4 dB; i.e., the data error rate would not be significantly increased if the system 10 were operating with the mean level of the OFDM signal set at about 4 dB below the 1 dB compression point of the system. In this alternate case, the pulse 28 would be set at a level approximately 4 dB above the mean level of the OFDM signal, and the pulse 29 would again be set at a level approximately 6 dB below the level of the pulse 28. It should be understood, however, that any other suitable type of power amplifier, and any other suitable levels for the respective pulses 28-29, may be employed.

With reference to FIG. 1, the OFDM symbol generator 11 generates the OFDM symbols in any suitable manner, and forms the OFDM symbols into transmit bursts of duration consistent with a given TDD structure. Next, the component 12 inserts the pulses 28-29 within the settling period 26 (see FIG. 2) of the power amplifier 16. The component 13 then up-converts the OFDM transmit bursts, and converts them to time domain samples, which are subsequently amplified by the variable gain amplifier 15. It is noted that the variable gain amplifier 15 may be disposed at any suitable point within the transmission path of the transmitter 1, but before the output of the power amplifier 16. In the presently disclosed embodiment, the gain of the variable gain amplifier 15 is set by the transmitter radio management component 14. Specifically, when power is applied to the wireless communications system 10, the transmitter radio management component 14 initially sets the gain of the variable gain amplifier 15 to a level suitable for maintaining the power amplifier 16 within its linear operating range. The transmitter radio management component 14 then incrementally increases the gain of the variable gain amplifier 15 in steps with each successive transmit burst until the cross correlation analysis results provided to the component 14 by the component 21 over the reverse radio link indicate that a maximal power level of the power amplifier 16, consistent with the required linearity of the modulation mode in operation, has been achieved. Next, the variable gain amplifier 15 provides the amplified signal to the power amplifier 16, which in turn provides the signal to the transmit antenna 3 for subsequent transmission over the radio link 17. It is noted that when the transmit antenna 3 transmits the wireless signal over the radio link 17, the signal may propagate along a dispersive channel. The system reduces the level of channel dispersion by employing the multiple sub-carriers in the OFDM signal waveform, and transmitting the wireless signal using the sub-carriers over multiple orthogonal channels. Because the sub-carriers in the OFDM waveform are orthogonal to each other, multi-path interference and frequency selective fading are also reduced.

The transmitted wireless signal is received by the receiver 2 at the receive antenna 4, and down-converted to an analog baseband signal, digitized, and normalized by the component 18. Next, the time domain representations of the pulses 28-29 contained in the received signal are sampled at baseband by the component 19. The component 20 then performs a cross correlation of the time domain samples corresponding to the pulse 28, and the time domain samples corresponding to the pulse 29. For example, the cross correlation operation may be carried out using a sliding complex dot product. Next, the component 21 analyzes the results of the cross correlation to determine the level of distortion in the pulse 28 relative to the pulse 29. As discussed above, a level of channel dispersion may be introduced when the wireless signal is transmitted over the radio link 17. The effect of such channel dispersion, however, is linear and not power-dependent. Because the proximity of the operation of the power amplifier 16 to the non-linear region and the level of distortion at the amplifier output are power dependent, differences between the time domain representations of the pulses 28-29 may be introduced based upon the levels of the respective pulses, resulting in a reduction in the magnitude of the cross correlation peak and/or a change in the phase of the cross correlation. It is noted that because the time domain representations of the pulses 28-29 are normalized by the component 18, the RMS voltage (V_{RMS}) of the received burst is constant regardless of the transmission power level. Accordingly, the transmission power level does not affect the cross correlation result, except by the introduction of distortion from operating in or near the non-linear region.

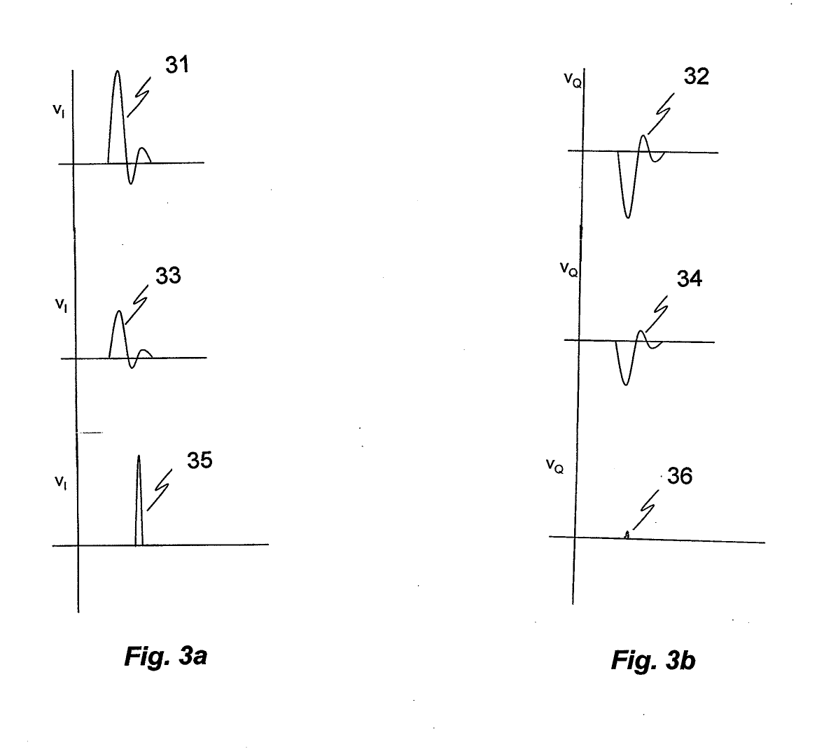

FIGS. 3a-3b depict exemplary complex time domain representations of the in-phase and quadrature components 31, 32 of the pulse 28 (see FIG. 2), exemplary complex time domain representations of the in-phase and quadrature components 33, 34 of the pulse 29 (see FIG. 2), and exemplary complex time domain representations 35, 36 of the cross correlations of the pulse components 31, 33 and 32, 34, respectively. As illustrated in FIGS. 3a-3b, each of the pulse components 31-34 corresponds to a pulse within the linear operating range of the power amplifier 16 (see FIG. 1); i.e., substantially no distortion is introduced onto the pulse components 31-34 because the power amplifier 16 is operating within the linear range.

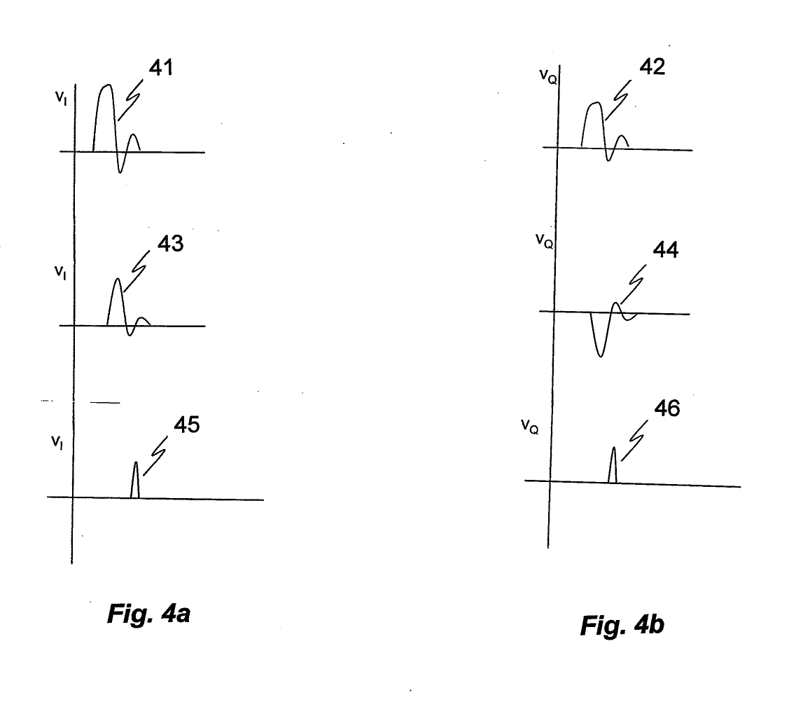

Similarly, FIGS. 4a-4b depict exemplary complex time domain representations of the in-phase and quadrature components 41, 42 of the pulse 28 (see FIG. 2), exemplary complex time domain representations of the in-phase and quadrature components 43, 44 of the pulse 29 (see FIG. 2), and exemplary complex time domain representations 45, 46 of the cross correlations of the pulse components 41, 43 and 42, 44, respectively. As illustrated in FIGS. 4a-4b, each of the pulse components 41-42, corresponding to the higher level pulse 28, is outside the linear operating range of the power amplifier 16 (see FIG. 1); i.e., a level of distortion is introduced onto the pulse components 41-42 due to the power amplifier 16 operating in or near the non-linear region. Each of the pulse components 43-44, corresponding to the lower level pulse 29, remains within the linear operating range of the power amplifier 16; i.e., substantially no distortion is introduced onto the pulse components 43-44.

Because a level of distortion is introduced onto the pulse components 41-42, due to the higher level of the pulse 28 causing the power amplifier 16 to operate in or near the non-linear region, the in-phase pulse component 31 (see FIG. 3a) and the in-phase pulse component 41 (see FIG. 4a) have different shapes. Similarly, the quadrature pulse component 32 (see FIG. 3b) and the quadrature pulse component 42 (see FIG. 4b) have different shapes. Because substantially no distortion is introduced onto the pulse components 43-44, due to the lower level of the pulse 29 causing the power amplifier 16 to remain within its linear operating range, the in-phase pulse component 33 (see FIG. 3a) and the in-phase pulse component 43 (see FIG. 4a) have substantially the same shape, and the quadrature pulse component 34 (see FIG. 3b) and the quadrature pulse component 44 (see FIG. 4b) have substantially the same shape. As a result, the peak magnitude of the cross correlation 45 (see FIG. 4a) of the in-phase pulse components 41, 43 is reduced compared with the peak magnitude of the cross correlation 35 (see FIG. 3a) of the in-phase pulse components 31, 33.

In addition, the phase of the cross correlation of the two pulses corresponding to the pulse components 41-42 and 43-44 has changed compared with the phase of the cross correlation of the two pulses corresponding to the pulse components 31-32 and 33-34, as evidenced by an increase in the magnitude of the quadrature component 46 (see FIG. 4b) compared with the quadrature component 36 (see FIG. 3b) of the respective cross correlations. It is noted that the phase change in the cross correlation can provide a sensitive measure of the linearity of the power amplifier 16. For example, if the spacing between the pulses 28-29 (see FIG. 2) is selected to be an integer multiple of the pulse sampling interval, then the peak of the cross correlation of the pulses 28-29 will be purely in-phase during linear operation of the power amplifier 16, as illustrated by the presence of the in-phase component 35 (see FIG. 3a) and the substantial absence of the quadrature component 36. Any increase in the quadrature component of the cross correlation will indicate the onset of non-linearity, as illustrated by the presence of the quadrature component 46 (see FIG. 4b). Accordingly, by monitoring the cross correlation of the pulses 28-29 (see FIG. 2) as the gain of the variable gain amplifier 15 is increased, the onset of non-linearity in the power amplifier 16 can be detected. In addition, acceptable levels of change in the peak magnitude and/or phase of the cross correlation can be calibrated in advance, according to the level of distortion at the output of the power amplifier 16 that is acceptable for the modulation mode currently being employed by the system.

With reference to FIG. 1, the component 18 included in the receiver 2 provides the digital time domain representations of the pulses 28-29 (see FIG. 2) to the OFDM symbol decoder 24, which in turn provides representations of the decoded OFDM symbols to the component 25. As described above, the component 25 is operative to measure the vector error associated with the received symbols. As shown in FIG. 1, the component 25 provides a measure of the vector error to the adaptive modulation and coding controller 23 over the reverse radio link.

Those of ordinary skill in this art will appreciate that the vector error can be determined by calculating the RMS value of the spread of the received symbols (constellation points) around the ideal (unperturbed) value of each symbol. For example, when a modulated signal is transmitted over a radio link and then demodulated, the detected symbol values may spread about each constellation point due to the effects of noise and interference on the radio link. The vector error can be determined by taking the RMS value of the ideal modulation vectors minus the actual measured modulation vectors converted to a power and divided by the power in the overall signal. The adaptive modulation and coding controller 23 can then subtract a predetermined level of distortion corresponding to the modulation mode in operation from the vector error to obtain the environmental noise plus front end thermal noise. For example, this predetermined distortion level may correspond to the distortion that results from complying with FCC regulations limiting the maximum power output. By subtracting the predetermined distortion level from the measure of the vector error, the adaptive modulation and coding controller 23 can determine whether the wireless communications system 10 will operate successfully in a next higher modulation level, even though a direct measurement of the signal-to-noise and distortion (SINAD) may indicate otherwise.

The transmitter radio management component 14 controls the variable gain amplifier 15 so that the transmission power of the power amplifier 16 is set at a maximal level, while maintaining an acceptable level of distortion at the output of the power amplifier 16. As described above, measures of the linearity of the power amplifier 16 and the distortion at the amplifier output may be obtained via the cross correlation of the pulses 28-29 (see FIG. 2) performed by the component 20 included in the receiver 2. Once the transmission power is set at the maximal level, the vector error, as measured by the component 25 within the receiver 2, may decrease due to the increased received signal strength. As a result, the adaptive modulation and coding controller 23 may then be able to select a higher modulation level and coding format, thereby increasing the data capacity of the radio link 17.

The cross correlation of the pulses 28-29 (see FIG. 2) may also be used by the transmission radio management component 14 to adjust the parameters of the digital pre-distortion characteristic applied to a data stream by the component 13 included in the transmitter 1 (see FIG. 1). Such digital pre-distortion of the data stream may be employed to compensate for the non-linear transfer characteristics of the power amplifier. As illustrated in FIG. 1, the component 13 applies the digital pre-distortion characteristic to the data stream prior to amplification by the power amplifier 16. For example, the pre-distortion parameters can be adjusted in an iterative fashion to maximize the peak magnitude and/or to minimize the phase change of the cross correlation of the pulses 28-29. In the presently disclosed embodiment, the transmitter radio management component 14 operates to adjust the transmission power of the power amplifier 16, and to adjust the parameters of the pre-distortion characteristic, based upon measures of the cross correlation of the pulses 28-29 associated with separate, typically alternate, transmit bursts.

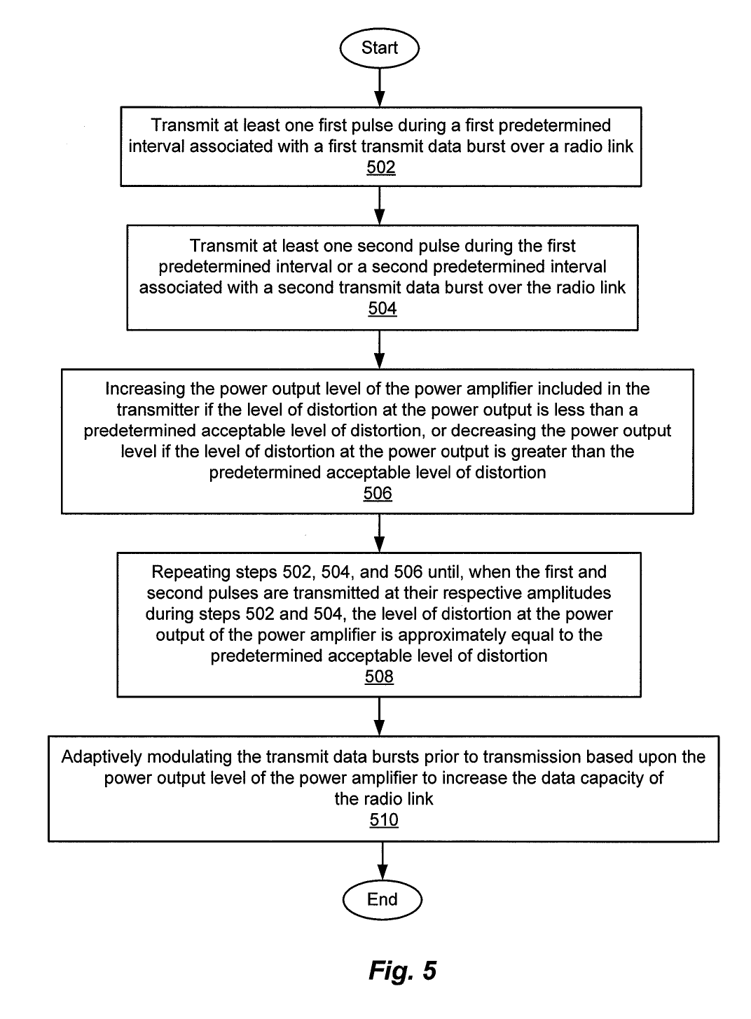

A method of operating the presently disclosed wireless broadband communications system 10 is described below with reference to FIGS. 1 and 5. As depicted in step 502 (see FIG. 5), at least one first pulse is transmitted by the transmitter 1 (see FIG. 1) during a first predetermined interval associated with a first transmit data burst over the radio link 17. The first pulse has an associated amplitude, and the transmitter 1, particularly, the power amplifier 16, has an associated power output. Next, at least one second pulse is transmitted by the transmitter 1 over the radio link, as depicted in step 504, during either the first predetermined interval or a second predetermined interval associated with a second transmit data burst. The second pulse has an associated amplitude. Further, the second pulse has a predefined amplitude and phase relationship relative to the first pulse. When the first and second pulses are transmitted at their respective amplitudes, a level of distortion is generated at the power output of the power amplifier 16. The power output level of the power amplifier 16 is then either increased if the level of distortion at the power output is less than a predetermined acceptable level of distortion or decreased if the level of distortion at the power output is greater than the predetermined acceptable level of distortion, as depicted in step 506. Next, steps 502, 504, and 506 are repeated, as depicted in step 508, until, when the first and second pulses are transmitted at their respective amplitudes during steps 502 and 504, the level of distortion at the power output of the power amplifier is approximately equal to the predetermined acceptable level of distortion. The respective transmit data bursts are then adaptively modulated, as depicted in step 510, prior to transmission by the transmitter 1 based upon the power output level of the power amplifier 16, thereby increasing the data capacity of the radio link 17. It is noted that the predetermined acceptable level of distortion at the output of the power amplifier can be adjusted based upon the instantaneous state of modulation.

It should be appreciated that the functions necessary to implement the present invention may be embodied in whole or in part using hardware, software, firmware, or some combination thereof using micro-controllers, microprocessors, digital signal processors, programmable logic arrays, or any other suitable types of hardware, software, and/or firmware.

It will further be appreciated by those of ordinary skill in the art that modifications to and variations of the above-described system and method of transmission power optimization may be made without departing from the inventive concepts disclosed herein. Accordingly, the invention should not be viewed as limited except as by the scope and spirit of the appended claims.

What is claimed is:

1. A method of operating a wireless communications system, comprising the steps of:
in a first transmitting step, transmitting a first pulse during a first predetermined interval associated with a first transmit data burst over a radio link, said first pulse having a first amplitude, said transmitter comprising a power amplifier having a power output;
in a second transmitting step, transmitting a second pulse during one of said first predetermined interval and a second predetermined interval associated with a second transmit data burst over said radio link, said second pulse having a second amplitude, said second pulse having a predefined amplitude and phase relationship relative to said first pulse,
wherein, when said first and second pulses are transmitted at their respective amplitudes, a level of distortion is generated at the power output of said power amplifier;
in a performing step, performing at least one of increasing the power output of said power amplifier in the event the level of distortion at the power output is less than a predetermined acceptable level of distortion and decreasing the power output of said power amplifier in the event the level of distortion at the power output is greater than the predetermined acceptable level of distortion;
repeating said first transmitting step, said second transmitting step, and said performing step until, when said first and second pulses are transmitted at their respective amplitudes during said first and second transmitting steps, the level of distortion at the power output of said power amplifier is approximately equal to the predetermined acceptable level of distortion; and
in a modulating step, adaptively modulating said respective transmit data bursts prior to transmission by said transmitter based upon the power output level of said power amplifier to increase a data capacity of said radio link.

2. The method of claim 1 wherein said modulating step comprises adaptively modulating said respective transmit data bursts according to an instantaneous state of modulation, and comprising the step of adjusting the predetermined acceptable level of distortion at the power output of said power amplifier based upon the instantaneous state of modulation.

3. The method of claim 1 comprising the steps of:
receiving, at a receiver, said first and second pulses transmitted over said radio link by said transmitter; and
performing a cross correlation of time domain representations of said received first and second pulses to obtain indications of at least one of a peak magnitude and a phase associated with said cross correlation,
wherein at least one of a reduction in said peak magnitude by a predetermined amount and a change in said phase by a predetermined amount is indicative of the operation of said power amplifier approaching said non-linear region.

4. The method of claim 1 wherein said first and second transmitting steps comprise transmitting said first and second transmit data bursts, respectively, over said radio link using a number of sub-carriers in an orthogonal frequency division modulation (OFDM) signal waveform, said OFDM signal waveform having an associated OFDM signal envelope.

5. The method of claim 4 wherein a level of one of the first amplitude of said first pulse and the second amplitude of said second pulse is greater than a mean level of said OFDM signal envelope.

6. The method of claim 1 wherein each of said first and second predetermined intervals corresponds to a settling period of said power amplifier.

7. A wireless communications system, comprising:
a transmitter comprising a power amplifier, said power amplifier having a power output,
wherein said transmitter is configured:
to transmit a first pulse during a first predetermined interval associated with a first transmit data burst over a radio link; and
to transmit a second pulse during one of said first predetermined interval and a second predetermined interval associated with a second transmit data burst over said radio link, said first and second pulses having first and second amplitudes, respectively, said second pulse having a predetermined amplitude and phase relationship relative to said first pulse,
wherein a level of distortion is generated at the power output of said power amplifier when said first and second pulses are transmitted at their respective amplitudes, and
wherein said transmitter is further configured:
to perform at least one of increasing the power output of said power amplifier in the event the level of distortion at the power output is less than a predetermined acceptable level of distortion and decreasing the power output of said power amplifier in the event the level of distortion at the power output is greater than the predetermined acceptable level of distortion until, when said first and second pulses are transmitted at their respective amplitudes, the level of distortion at the power output of said power amplifier is approximately equal to the predetermined acceptable level of distortion; and
to adaptively modulate said respective transmit data bursts prior to transmission based upon the power output level of said power amplifier to increase a data capacity of said radio link.

8. The system of claim 7 wherein said transmitter is configured to adaptively modulate said respective transmit data bursts according to an instantaneous state of modulation, and wherein the predetermined acceptable level of distortion at the power output of said power amplifier is adjusted based upon the instantaneous state of modulation.

9. The system of claim 7 comprising at least one receiver configured to receive said first and second pulses transmitted over said radio link by said transmitter,
wherein said receiver is configured to perform a cross correlation of time domain representations of said received first and second pulses to obtain indications of at least one of a peak magnitude and a phase associated with said cross correlation, and
wherein at least one of a reduction in said peak magnitude by a predetermined amount and a change in said phase by a predetermined amount is indicative of the operation of said power amplifier approaching said non-linear region.

10. The system of claim 7 wherein said transmitter is configured to transmit said first and second transmit data bursts over said radio link using a number of sub-carriers in an orthogonal frequency division modulation (OFDM) signal waveform, said OFDM signal waveform having an associated OFDM signal envelope.

11. The system of claim 10 wherein a level of one of the first amplitude of said first pulse and the second amplitude of said second pulse is greater than a mean level of said OFDM signal envelope.

12. The system of claim 7 wherein each of said first and second predetermined intervals corresponds to a settling period of said power amplifier.
